(19) United States
(12) Patent Application Publication
(10) Pub. No.: US 2007/0240227 A1
(43) Pub. Date: Oct. 11, 2007

(54) Managing an entity

(76) Inventors: Dale M. Rickman, Kensington, MD (US); Stephen R. Marley, Tracys Landing, MD (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/392,246

(22) Filed: Mar. 29, 2006

(51) Int. Cl. H04L 9/32

(52) U.S. Cl. 726/27

(57) ABSTRACT

In one aspect the invention is a method of managing an entity. The method includes associating an identity of an entity to reputation data, associating a rule to the identity based on status data and the reputation data associated with the identity. The method also includes determining a response based on the rule associated with the identity.

### TECHNICAL FIELD

The invention relates to entity management.

### BACKGROUND

Typically, entity management has been associated with people and objects. For example, management of people may include scanning into a system a document such as a passport or driver's license or typing a document number of the document into the system and receiving back from the system an indication of whether that document is considered valid. In some instances, the validity determination of the document determines what response should be taken with respect to the person (e.g., denying or allowing entry into a country). In other instances, a particular action is associated with the document. For example, if the passport is determined to be invalid, the action would be to detain the individual using the passport.

### SUMMARY

In one aspect, the invention is a method of managing an entity. The method includes associating an identity of the entity to reputation data, associating a rule to the identity based on status data and the reputation data associated with the identity. The method also includes determining a response based on the rule associated with the identity.

In another aspect, the invention is a system for managing an entity. The system includes a reputation database having reputation data, a status database having status data and a rules engine configured to interact with the reputation database and the status database. The rule engine is configured to determine a response based on the status data and the reputation data associated with an identity of the entity.

In a further aspect, the invention is an article. The article includes a machine-readable medium that stores executable instructions for managing an entity. The instructions cause a machine to associate an identity of the entity to reputation data, associate a rule to the identity based on the reputation data and status data and determine a response based on the status data and the rule associated with the identity.

In a still further aspect, the invention is a method of managing people entering a country. The method includes verifying an identity of a person entering the country, associating the identity to reputation data, associating a rule to the identity based on status data and the reputation data associated with the identity and determining a response based on the rule associated with the identity.

In a still further aspect, the invention is a method of managing security for a system. The method includes verifying the identity of a person or software application, associating the identity to reputation data, associating a rule to the identity based on status data and the reputation data associated with the identity and determining the data and services the identity is allowed to use. The method may also include returning a Public Key infrastructure (PKI) token to the person or software application. The PKI token may be used by the person or software to request services or access data. Otherwise, the person or software application cannot access services or decrypt data without the corresponding PKI token.

### DESCRIPTION OF THE DRAWINGS

FIG. 1 is a functional diagram of an entity management system.

FIG. 2 is a flowchart of a process for managing an entity.

FIG. 3 is an example of associating reputation data to the identity.

FIG. 4 is an example of associating rules to the identity.

FIG. 5 is a block diagram of a computer system on which the process of FIG. 2 may be implemented.

### DETAILED DESCRIPTION

Described herein is an inventive approach for entity management. While the examples described herein are used for entity management, the invention is not limited to the examples described herein; but rather, the invention may be used in any system or process which manages an entity.

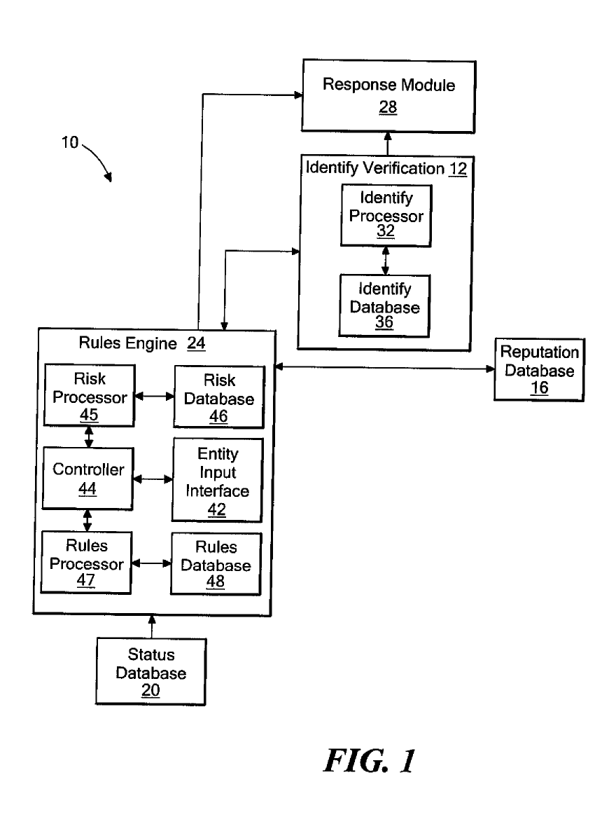

Referring to FIG. 1, an entity management system (EMS) 10 includes an identity verification component 12, a reputation database 16, a status database 20, a rules engine 24 and a response module 28. As will be further described herein, the EMS 10 may be used to determine a response using the response module 28 with respect to an entity. The response module 28 may provide granting the entity entitlements and/or a listing of actions that are to be executed with respect to the entity. The entity may be a person, animal, an organism (e.g., a virus), an object, a system or any combination thereof.

The identity verification component 12 verifies an identity of an entity. For example, the entity may be a person seeking access to a secure facility. In another example, the entity may be a shipping package entering a country and being processed at customs. In a further example, the entity may be a cow entering a country. In a still further example, the entity may be a first system (e.g., a software application) seeking access to a second system. In another example, the entity may also be an organism, such as a virus detected. In other examples, entities may be devices used to access a system, such as a personal data assistant (PDA), a cell phone or a wireless radio. In a further example, an entity may be a credit card.

The identity verification component 12 includes an identity processor 32 and an identity database 36. The identity database 36 includes identity data used to identify an entity. The identity data may be biometric data, a shipping label, a scanned passport and so forth. The identity data is associated with a unique identifier indicating an identity. For example, a single fingerprint scan would be associated with one unique identifier. The identity processor 32 receives entity data from the rules engine 24 and determines from the identity data in the identity database 36 an identity of the entity.

In one example, the identity data is stored during an initialization process such as an enrollment process. For example, a foreign traveler requesting a visa would be enrolled in the system. Subsequent access by an entity to EMS 10 involves comparing the entity data during the subsequent access with the identity data stored in the identity database 36. For example, when the foreign traveler arrives at immigration.

The reputation database 16 includes historical data on one or more identities. The historical data is associated with identities by unique identifiers. The historical data may include past movements of the identity. For example, the historical data may include overstays (i.e., staying in a country beyond a time authorized by a visa) of an individual in a country. The historical data may also include past actions by the identity. For example, the past actions may include payment history or attendance at insurgency meetings. In another example, past actions may include passing through ports of entry in a country by the identity and the times for entry by the identity. The reputation database 16 may also include relationship data of identities. For example, the relationship data may include connections to other individuals, groups (e.g., families, types of services, organizations), communities of interest (e.g., geographic area), roles, applications and so forth). The reputation database 16 may further include recommendation data. For example, the recommendation data may include a third party recommendation on an action to take with the identity, such as grant the identity access.

The reputation database 16 may also include a third party validation. For example, in enrolling a large number of entities, it may be more efficient to have the entities enroll themselves; but before enrollment completes, the entities are validated by a trusted third party. For example, employees requesting access to a building or a service can enter their own information, but before the enrollment can be completed their information and reputation would be validated by a security officer or their manager. In another example, a shipper's reputation may be established by a third party independent firm that is willing to certify the shipper. In a further example for obtaining a top secret clearance, third party validation may be an indication that the government had already performed a detailed background check.

The reputation database 16 may be one database or a combination of databases spread over a wide geographic area (e.g., across a continent or several continents) and connected by a network. In one example, the reputation database 16 may be in one location. In another example, the reputation database 16 may include portions located in different locations. The reputation database 16 may be a part of a single computer or a group of computers.

In other examples, a complete reputation database may not be included in the EMS 10. For example, an external database (not shown) may be queried to access reputation data. Specifically, an INTERPOL database of lost/stolen passports may be checked in an example of the EMS 10 used to manage travelers entering a country.

The status database 20 includes status data. The status data may indicate the environment within which the EMS 10 operates or a portion of the environment within which the EMS 10 operates. For example, the status data may be a threat advisory level or a security alert. The status data may further indicate what a future environment will be. For example, on a future specified date a security threat level will go from high to low. In another example, the status data may indicate hours of operation at a facility using the EMS 10.

In one example, status data may be any information that would affect a large set of the population (as opposed to a specific individual or item). For example, a security breach where personal information may have been lost (e.g., lost personal identification numbers (PIN)). In another example, status data may include weather data. In a further example, status data may include temperature data of building or ship.

The rules engine 24 includes an entity input interface 42, a controller 44, a risk processor 45, a risk database 46, a rules processor 47 and a rules database having rules 49. The entity input interface 42 receives information from the entity to determine the identity of the entity. In one example, the entity input interface 42 is a document reader which scans bar codes on a document (e.g. a passport, a driver's license, shipping label and so forth). In another example, the entity input interface 42 is biometric scanner that scans biometric data such as a fingerprint, an iris, a voice, DNA and so forth. In a further example, the entity input interface 42 is a computer program that reads a secured encryption key.

In other examples, the entity input interface 42 includes a radio frequency identification (RFID) reader for reading RFID tags. In other examples, the entity input interface 42 may receive a user name and password. In further examples, entity input interface 42 may be a device that images the contents of a cargo container at a departure location and another entity input interface (not shown) may image the container at the arrival location. The verification component 12 would verify the container by comparing the two images that the container is the same container and that the container has not been tampered with along the way.

The controller 44 controls the flow of information to and from components external and internal to the rules engine 24. For example, the controller 46 sends entity data received by the entity input interface 42 to the identity verification component 12. The controller 46 also accesses databases such as the reputation database 16 and the status database 20. The controller 44 also controls the risk processor 45 and the rules processor 47. The controller 22 sends a signal to the response module 28 indicating a response to the entity interaction with EMS 10.

The risk processor 45 associates the reputation data for an identity in the reputation database 16 with risk criteria stored in the risk database 46. In one example, the rules processor 45 assigns a risk score based on the reputation data associated with the identity.

The rules processor 47 determines a response for the response module 28 from the rules in the rules database 48 based on the status data from the status database 20 and the reputation data associated with the identity from the reputation database 16. In one example, an identity enters a country having two ports of entry, Port A and Port B. The reputation data may include times of entry into a country and ports of entry. The reputation data associated with an identity indicates that in the past the individual enters Port A every weekday morning. Next, the identity enters Port B late in the evening. Rule engine 24 would detect this change in behavior and associate a rule (e.g., stop the identity) to the identity using the status data. For example, status data indicating a high threat level may require stopping and searching the identity while a status data indicating a low threat level may not require stopping and questioning the identity. Another example of a status data change may include access codes for intelligence information being compromised thereby increasing the rules for more oversight.

The response module 28 may also provide an action to be conducted by the users of EMS 10. For example, if EMS 10 is used at a country's immigration center, the response module 28 may be to ask the identity further probing questions. In another example, the response module 28 may provide an entitlement or privilege such as access to a computer, authorization to enter a restricted area and so forth.

In some examples, the response model 28 may render displays results (e.g., a message on a computer screen), or the response module 28 may control a physical device. For example, in examples where the EMS 10 is used to control luggage being unloaded from a plane, the response module 28 may physically route high risk bags to a separate area for a detailed examination. If the EMS 10 were used in a registered travel program, the response module 28 may open gates for either allowing entrance or to route people to a place for a secondary inspection.

In some examples, EMS 10 may not include the response module 28. For example, if EMS 10 is embodied in software used by an application, the response (e.g., a message) may be returned directly to the application.

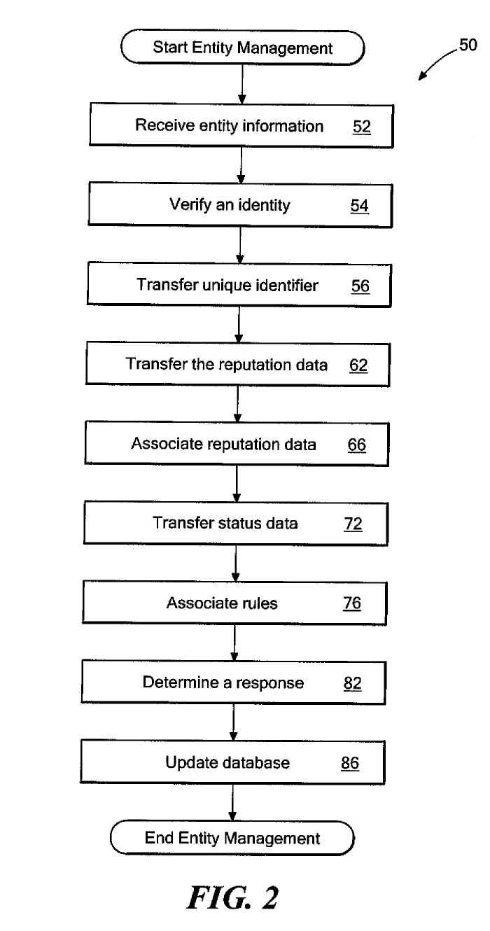

Referring to FIG. 2, an exemplary process for managing an identity is a process 50. Process 50 receives entity data (52). For example, entity data is received by the entity input interface 42 that will be used to determine the identity of the entity. For example, the entity presents a document (e.g., a passport, a driver's license and so forth) which is scanned into entity input interface 42. In another example, biometric data (e.g., a fingerprint scan, voiceprint scan, an iris scan, DNA and so forth) is read from the entity and downloaded into the entity input interface 42. In a further example, a secured encryption key is presented to the entity input interface 42 through a communications link. In a still further example, a shipping label attached to the entity is scanned.

Process 50 verifies an identity from the entity information (54). For example, the entity data is sent by the controller 44 to the identity verification component 12. The identity processor 32 compares the entity data with the identity data stored in the identity database 36. For example, the identity processor 32 searches the identity database using the fingerprint scanned by the entity input interface 42 for a matching fingerprint or a matching fingerprint with a certain tolerance. The matched fingerprint is associated with a unique identifier that identifies the entity as a particular identity.

Process 50 transfers the unique identifier to the rules engine 20 (56). In one example, the controller 44 retrieves the unique identifier from the identity verification component 12. In another example, the identity verification component 12 sends the unique identifier to the controller 44.

Process 50 transfers the reputation data associated with the unique identifier (62). For example, the controller 44 retrieves the reputation data from the reputation database 16 using the unique identifier. In another example, when the reputation database 16 is distributed, the controller 44 sends an initial query to one portion of the reputation database 16. The reputation database 16 generates queries to the remaining portions of the reputation database 16, waits for the response from the remaining portions of the reputation database 16 and returns a consolidated response to the rules engine 24.

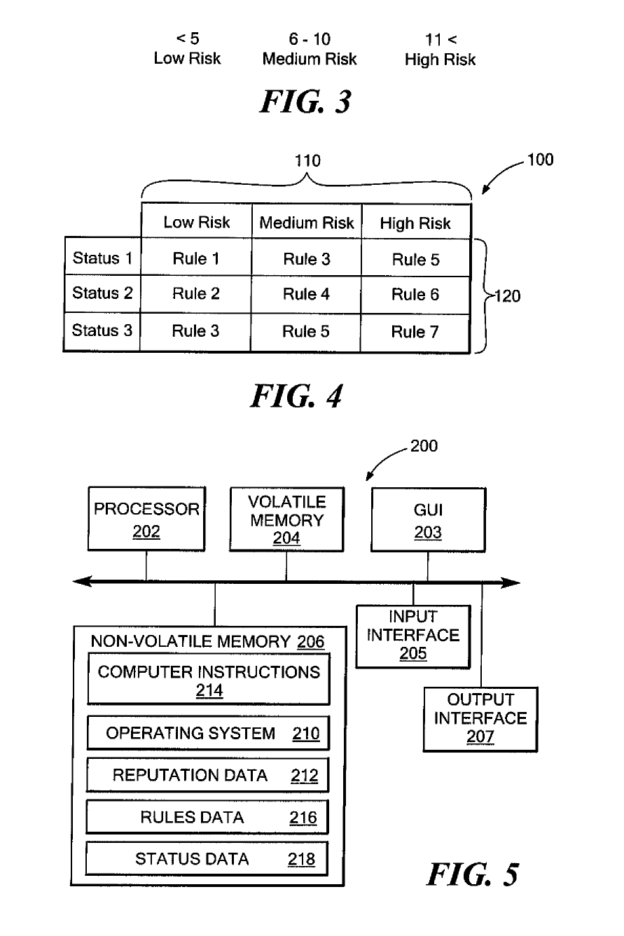

Process 50 associates the reputation data (66). For example, controller 44 sends the reputation data associated with a unique identifier to the risk processor 45. The risk processor 45 applies the risk criteria from the risk database 46 and assigns a numeric score indicating risk (risk score). Another example of associating the reputation data is described below in reference to FIG. 3.

Process 50 transfers status data (72). For example, controller 44 retrieves status data from the status database 24. In another example, status database 24 sends the status data to the controller 44. In other examples, transfer of the status data may occur periodically or when changes to the status data occur.

Process 50 associates the rules to the identity based on the status data and the reputation data associated with the identity (76). For example, the controller sends the associated reputation data and the status to the rules processor 47. The rule processor 47 applies the rules form the rules database 48. An example of associating the rules is described below in reference to FIG. 4.

Process 50 determines a response based on the association of the rules (82). For example, the controller 44 sends a signal to the response module 24 to perform a response. Process 50 updates reputation databases (86). For example, the reputation database 16 is updated after it receives notification by the controller 44 that an entity is interacting with the EMS 10 in block 56. For example, each time a traveler enters a country; a new history record is generated.

Referring to FIGS. 3 and 4, it will be appreciated by those of ordinary skill in the art that there are a variety of ways to store data, represent data and associate data within EMS 10. In one example where EMS 10 is used at an airport for receiving passengers from foreign countries, associating reputation data (block 66 of FIG. 2) may be performed by assigning a score and representing that score with a risk level. For example, a formula (risk criteria) may be used to assign a score to the reputation data associated with the identity and further associating that score with a risk level. If, from the reputation data, the identity appears on a watch list, has associations with terrorists organizations and so forth a score may be assigned of an “11” or greater representing a “High Risk” entity. If from the reputation data, the identity is a new traveler and unknown, a score may be assigned between “6” and “10” representing a “Medium Risk” entity. If, from the reputation data, the identity is a frequent traveler and does not appear on any lists, then the identity would be associated with a score less than “5” representing a “Low Risk” entity.

Continuing the example in the previous paragraph, associating rules (block 76 of FIG. 2) may be represented by a table 100, having columns 110 representing risk levels (e.g., risk levels in FIG. 3) from the reputation data and rows 120 representing status levels (e.g., Status 1, Status 2 and Status 3) from the status data. Status 1 may represent a low threat level, Status 2 may represent a medium threat level and Status 3 may represent a high threat level. Each row/column combination is associated with a rule (e.g., Rule 1, Rule 2, Rule 3, Rule 4 and Rule 5). Rule 1 may be to let the identity enter the country. Rule 2 may be to question the identity with a set of questions. Rule 3 may be to search belongings of the identity. Rule 4 may be to search the body of the identity. Rule 5 may be to arrest the identity. Thus, using the table 100, the rules engine 2 may take the status data and reputation data associated with the identity to associate a rule to the identity to determine a response (e.g., block 82 of FIG. 2).

Other examples may be used to associate reputation data. In an example of processing travelers into a country, until the traveler has entered the country and left on-time a certain number of times (e.g., >10), the traveler may not be eligible for a low risk score. In another example, a traveler who has traveled often and never has had an overstay would be rated a low risk. In a further example, appearing on a watch list or having a lost or stolen passport may automatically change the rules related to the traveler.

In an example for cargo entering a country, the association would take into account the number of years the shipper has been sending cargo to the country, how many times the cargo has been inspected and/or the number of problems encountered. In addition to a shipper's history, risk may be calculated based on the types of items being shipped. For example, textiles might be assigned a low risk, while electronics automatically are assigned at least a medium risk and radioactive material are always assigned a high risk and subject to search.

Another example of associating reputation data is exemplified in an online auction model, where people rate each other based on transactions between them. For example, a high risk may be assigned to someone who has only had a couple of transactions with the system. In another example, a high risk may be assigned to a person who has received a lot of negative comments.

It will be appreciated by those of ordinary skill in the art that the EMS 10 may be applied to other examples than those described herein.

In one example, EMS 10 may be used at a border of a country to process cattle entering a country. In this example, the identity verification may include reading an ear tag. The reputation data may include a history of the cow's movements. The history of the cow's movements may include which other cows the cow interacted with during its past movements including which other cows later were identified with mad cow disease. The reputation data may also include a reputation of a cattle shipper or the reputation of the country providing the cattle. For example, cattle from a country that has never had mad cow disease would be a lower risk than a country that has recently had an outbreak of the mad cow disease. Further, the status data may be the state of the meat industry such as recent mad cow alerts.

In another example, EMS 10 may be used in processing shipping packages being processed through a port of entry. In this example, the identity verification may include reading the shipping label. In another example, identity verification may include scanning the contents of the package. The reputation data may be associated with the shipper (e.g., whether the shipper is reputable or not). In this example, EMS 10 may be used to determine what response is appropriate for each package received. The reputation data may include the country of origin. For example, packages from countries known for drug smuggling would have a high risk than countries with no previous problems.

In a further example, the EMS 10 may be used in a communication system having a main server and wireless radios. The reputation data may include the times and duration each wireless radio interacts with the server. In this example, EMS 10 may be used to identify those wireless radios not interacting with the server for long periods of time which may indicate compromise by an enemy. EMS 10 may introduce additional security protocols to verify that the user of the wireless radio is a friendly. In another example, the reputation data may include previous data accessed and services requested which are compared against current or recent requests in order to detect a change. A change may indicate a higher risk.

In a still further example, EMS 10 may be used by government agencies, for example, the Veterans Administration (VA). In particular, veterans qualify for different benefits depending on the period of their military service (e.g., peacetime or wartime) and the duration of their service. An EMS 10 may be used to ensure that appropriate benefits are bestowed to each veteran. The benefits also change from time to time based on changes in the law. Reputation data may also include where the veteran has applied for benefits and types of benefits requested. For example, new types of requests or requests made at multiple VA offices may indicate a risk and would trigger different rules being implemented. A status change may include a veteran records being lost or stolen.

In a further example, the EMS 10 may used with credit cards, not just for allowing/denying a purchase, but also determining if the credit limit should be changed. In another example, if a large number of bankcard PINs were stolen, the EMS 10 may be used to detect unusual activity (using reputation data), with a change of status data, to disable the PINs on a large set of bankcards.

FIG. 5 shows a computer 200, which may be used to execute process 50. Computer 200 includes a processor 202, a volatile memory 204 and a non-volatile memory 206 (e.g., hard disk). Non-volatile memory 206 includes an operating system 210, reputation data 212, rules data 216, status data 218 and computer instructions 214 which are executed out of volatile memory 204 to perform process 50. The computer 200 also includes a graphical user interface (GUI) 203, an input interface 205 and an output interface 207. The GUI 203 may be used by a user to input data (e.g., entity data such as passport numbers) and receive data (e.g., a response module 28 such as instructions) sent by the processor 202. The input interface 205 may be a scanner, biometric analyzer and so forth used in receiving the entity data (e.g., entity input interface 42 of FIG. 1). The output interface 207 may be any device that executes the response. For example, the output interface 207 may be used to interact and releasing a gate to allow entry or send an authentication key across a network.

Process 50 is not limited to use with the hardware and software of FIG. 5; it may find applicability in any computing or processing environment and with any type of machine or set of machines that is capable of running a computer program. Process 50 may be implemented in hardware, software, or a combination of the two. Process 50 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 50 and to generate output information.

The system may be implemented, at least in part, via a computer program product, (i.e., a computer program tangibly embodied in an information carrier (e.g., in a machine-readable storage device or in a propagated signal)), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 50. Process 50 may also be implemented as a machine-readable storage medium, configured with a computer program, where upon execution, instructions in the computer program cause the computer to operate in accordance with process 50.

The processes described herein are not limited to the specific embodiments described herein. For example, the processes are not limited to the specific processing order of FIG. 2. Rather, any of the blocks of FIG. 2 may be re-ordered, combined or removed, performed in parallel or in serial, as necessary, to achieve the results set forth above. The controller 44, the risk processor 45 and the rules processor 47 may be combined to form one processor. The risk database 46 and the rules database 48 may be combined to form one database.

The system described herein is not limited to use with the hardware and software described above. The system may be implemented in digital electronic circuitry, or in computer hardware, firmware, software, or in combinations thereof.

Method steps associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

Elements of different embodiments described herein may be combined to form other embodiments not specifically set forth above. Other embodiments not specifically described herein are also within the scope of the following claims.

What is claimed is:

1. A method of managing an entity, comprising:
associating an identity of the entity to reputation data;
associating a rule to the identity based on status data and the reputation data associated with the identity; and
determining a response based on the rule associated with the identity.

2. The method of claim 1, further comprising verifying the identity of the entity.

3. The method of claim 2 wherein verifying the identity comprises verifying the identity of a life form.

4. The method of claim 2 wherein verifying the identity comprises verifying the identity of an object.

5. The method of claim 2 wherein verifying the identity comprises verifying the identity of a system.

6. The method of claim 1 wherein associating the identity to reputation data comprises associating the identity to a previous action by the identity.

7. The method of claim 1 wherein associating the identity to reputation data comprises associating the identity to a group of entities.

8. The method of claim 1 wherein associating the identity to the reputation data comprises associating the identity to a geographic location.

9. The method of claim 1 wherein determining the response comprises determining an action.

10. The method of claim 1 wherein determining the response comprises determining entitlements for the identity.

11. A system for managing an entity, comprising:
a reputation database having reputation data;
a status database having status data; and
a rules engine configured to interact with the reputation database and the status database, the rule engine configured to determine a response based on the status data and the reputation data associated with an identity of the entity.

12. The system of claim 11, further comprising an identity verification component configured to be connected to the rules engine and wherein the identity verification component verifies the identity of the entity.

13. The system of claim 12 wherein the entity comprises a lifeform.

14. The system of claim 12 wherein the entity comprises an object.

15. The system of claim 12 wherein the entity comprises a system.

16. The system of claim 11 wherein the rules engine associates the identity to a previous action by the identity.

17. The system of claim 11 wherein the rules engine associates the identity to a group of entities.

18. The system of claim 11 wherein the rules engine is configured to associate the identity to a geographic location.

19. The system of claim 11 wherein the rule engine configured to determine the response comprises the rule engine being configured to determine an action.

20. The system of claim 11 wherein the rule engine configured to determine the response comprises the rule engine being configured to determine entitlements for the identity.

21. An article comprising a machine-readable medium that stores executable instructions for managing an entity, the instructions causing a machine to:
associate an identity of the entity to reputation data;
associate a rule to the identity based on the reputation data and status data; and
determine a response based on the status data and the rule associated with the identity.

22. The article of claim 21, further comprising the instructions causing the machine to verify the identity of the entity.

23. The article of claim 22 wherein the instructions causing the machine to verify the identity comprises verifying the identity of a lifeform.

24. The article of claim 22 wherein the instructions causing the machine to verify the identity comprises instructions causing the machine to verify the identity of an object.

25. The article of claim 22 wherein the instructions causing the machine to verify the identity comprises instructions causing the machine to verifying the identity of a system.

26. The article of claim 21 wherein the instructions causing the machine to associate the identity to reputation data comprises instructions causing the machine to associate the identity to a previous action by the identity.

27. The article of claim 21 wherein the instructions causing the machine to associate the identity to reputation data comprises instructions causing the machine to associate the identity to a group of entities.

28. The article of claim 21 wherein the instructions causing the machine to associate the identity to the reputation data comprises instructions causing the machine to associate the identity to a geographic location.

29. The article of claim 21 wherein the instructions causing the machine to determine the response comprises instructions causing the machine to determine an action.

30. The article of claim 1 wherein the instructions causing the machine to determine the response comprises instructions causing the machine to determining entitlements for the identity.

31. A method of managing people entering a country, comprising:
verifying an identity of a person entering a country;
associating the identity to reputation data;
associating a rule to the identity based on status data and the reputation data associated with the identity; and
determining a response based on the rule associated with the identity.

32. The method of claim 31, further comprising verifying the identity of the person.

33. The method of claim 31 wherein associating the identity to reputation data comprises associating the identity to a previous action by the person.

34. The method of claim 31 wherein associating the identity to reputation data comprises associating the identity to a group of people.

35. The method of claim 31 wherein associating the identity to the reputation data comprises associating the identity to a geographic location.

36. The method of claim 31 wherein determining the response comprises determining an action.

37. The method of claim 31 wherein determining the response comprises determining entitlements for the identity.

38. A method of managing security for a system comprising:
verifying an identity of an entity;
associating the identity to reputation data;
associating a rule to the identity based on status data and the reputation data associated with the identity; and
determining the data and services the identity is allowed to use.

39. The method of claim 38 wherein verifying an identity of an entity comprises verifying a person.

40. The method of claim 38 wherein verifying an identity comprises verifying the identity of a software application.

41. The method of claim 3 8, further comprising returning a public key infrastructure (PKI) token to the entity.
